(19) United States
(12) Patent Application Publication
(10) Pub. No.: US 2014/0131065 A1
(43) Pub. Date: May 15, 2014

(54) TOUCH ELECTRODE DEVICE

(71) Applicant: HENGHAO TECHNOLOGY CO. LTD, Taoyuan County (TW)

(72) Inventor: Yen-Chun PENG, Taoyuan County (TW)

(73) Assignee: HengHao Technology Co. LTD, Taoyuan County (TW)

(21) Appl. No.: 13/725,153

(22) Filed: Dec. 21, 2012

(30) Foreign Application Priority Data
Nov. 9, 2012 (TW) 101141954

(51) Int. Cl. H01B 1/00

(52) U.S. Cl. CPC H01B 1/00
USPC 174/126.1

(57) ABSTRACT

A touch electrode device includes a substrate and at least one electrode layer. The electrode layer is disposed above a surface of the substrate. The electrode layer includes non-transparent conductive material.

### CROSS-REFERENCE TO RELATED APPLICATIONS

The entire contents of Taiwan Patent Application No. 101141954, filed on Nov. 9, 2012, from which this application claims priority, are incorporated herein by reference.

### BACKGROUND OF THE INVENTION

1. Field of the Invention

The present invention generally relates to a touch electrode device, and more particularly to a touch electrode device having electrodes made up of non-transparent conductive material.

2. Description of Related Art

A touch screen is an input/output device that adopts sensing technology and display technology, and has been widely employed in electronic devices such as portable or hand-held electronic devices.

A capacitor-based touch panel is a commonly used touch panel that utilizes capacitive coupling effect to detect touch position. Specifically, capacitance corresponding to the touch position changes and is thus detected, when a finger touches a surface of the touch panel.

FIG. 1A shows a top view of a conventional touch panel, and FIG. 1B shows a cross-sectional view along a section line 1B-1B′ in FIG. 1A. Specifically, first electrodes 12 are formed on a top surface of a substrate 10, and second electrodes 14 are formed on a bottom surface of the substrate 10. The first electrodes 12 and the second electrodes 14 may be substantially orthogonal to each other.

The first electrodes 12 and the second electrodes 14 of the conventional touch panel as discussed above are commonly made up of transparent conductive material such as indium tin oxide (ITO). The ITO is formed by using a complex process. Moreover, as the ITO fractures when it is bent, the ITO thus cannot afford to make a flexible touch panel.

For the reason that the conventional touch panel requires complex manufacturing process and cannot afford to make a flexible touch panel, a need has thus arisen to propose a novel touch electrode device to overcome disadvantages of the conventional touch panel.

### SUMMARY OF THE INVENTION

In view of the foregoing, it is an object of the embodiment of the present invention to provide a touch electrode device for manufacturing a flexible touch electrode device having electrodes made up of non-transparent conductive material, or simplifying process by directly performing photolithography.

According to one embodiment, a touch electrode device includes a substrate and at least one transparent electrode layer. The electrode layer is directly or indirectly disposed on a surface of the substrate, and the electrode layer includes non-transparent conductive material.

### BRIEF DESCRIPTION OF THE DRAWINGS

FIG. 1A shows a top view of a conventional touch panel;

FIG. 1B shows a cross-sectional view along a section line 1B-1B′ in FIG. 1A;

FIG. 2A shows a top view of a touch electrode device according to one embodiment of the present invention;

FIG. 2B shows a cross-sectional view along a section line 2-2′ in FIG. 2A;

FIG. 2C shows a partial enlarged section of the electrode layer in FIG. 2A;

FIG. 2D shows an electrode column formed by the photolithographic process;

FIG. 2E shows a cross-sectional view of a modified touch electrode device;

FIG. 3A shows a top view of a touch electrode device according to another embodiment of the present invention;

FIG. 3B shows a cross-sectional view along a section line 3-3′ in FIG. 3A;

FIG. 4A shows a top view of a touch electrode device according to another embodiment of the present invention;

FIG. 4B shows a cross-sectional view along a section line 4-4′ in FIG. 4A;

FIG. 5A and FIG. 5B show cross-sectional views of touch displays adopting the embodiment;

FIG. 6 shows a cross-sectional view of a touch panel adopting the embodiment; and

FIG. 7 shows a partial enlarged section of the electrode layer made of a copper mesh, according to another embodiment of the present invention.

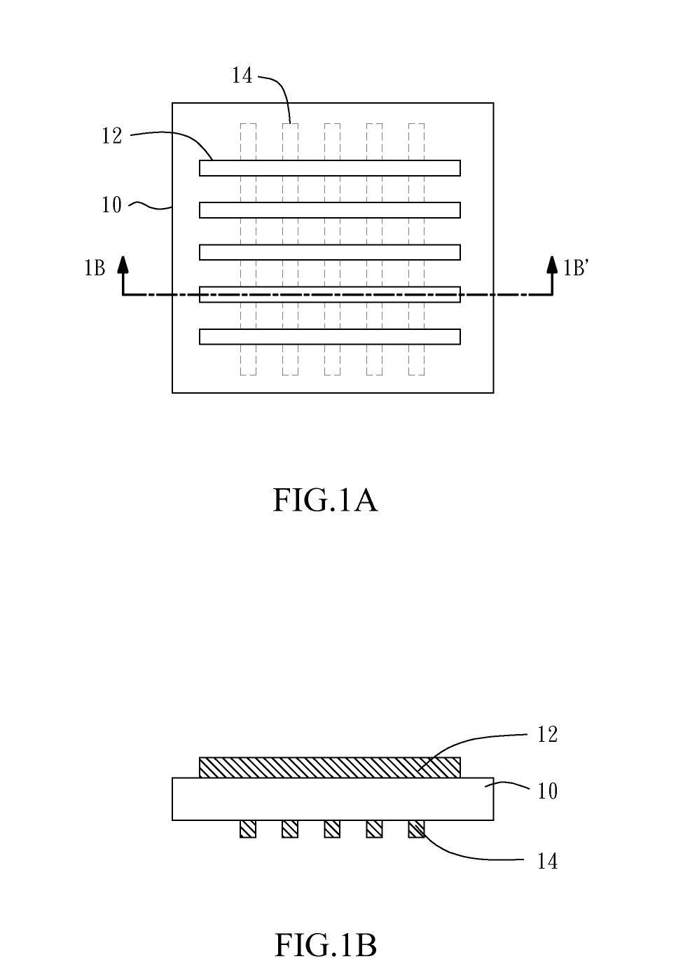

### DETAILED DESCRIPTION OF THE INVENTION

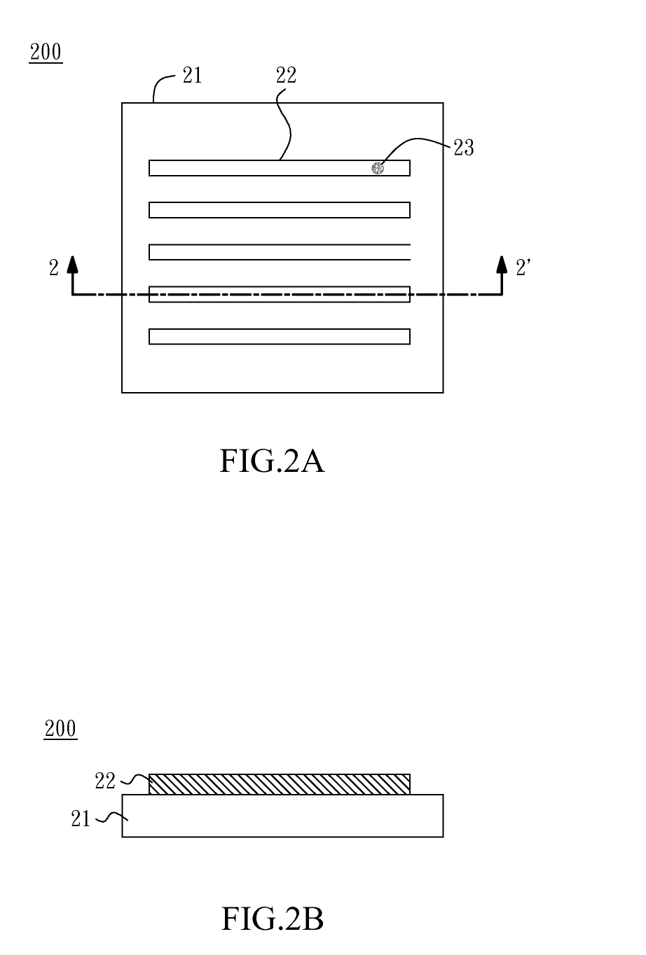

FIG. 2A shows a top view of a touch electrode device 200 according to one embodiment of the present invention, and FIG. 2B shows a cross-sectional view along a section line 2-2′ in FIG. 2A. Only composing elements pertinent to the embodiment are shown in the figures. The touch electrode device 200 of the embodiment includes a substrate 21 and at least one electrode layer 22, which may, but not necessarily, be disposed on a surface (e.g., a top surface) of the substrate 21. According to one aspect of the embodiment, the electrode layer 22 includes non-transparent conductive material, such as metal wires, a copper mesh or a silver mesh. Each metal wire has a diameter of some nanometers to hundreds of nanometers. This embodiment of the present invention is illustrated with the metal wires.

The metal wires 24 are fixed, by plastic material (e.g., resin) or photosensitive (e.g., acrylic), in the electrode layer 22. As the metal wires 24 are too thin to be observed by human eyes, the electrode layer 22 made of the metal wires 24 thus has high transmittance.

FIG. 2C shows a partial enlarged section 23 of the electrode layer in FIG. 2A. As shown in FIG. 2C, the metal wires 24 are interleaved with each other and flatly distributed in the electrode layer 22. As the electrode layer 22 is made of the metal wires, therefore having an isotropic conductivity, which is substantially invariant with respect to direction.

According to another aspect of the embodiment, if the electrode layer 22 includes photosensitive material (e.g., acrylic), the electrode layer 22 may be subjected directly to a photolithographic process to result in the patterned electrode column 26 with required pattern. In an embodiment, as shown in FIG. 2D, each electrode of the electrode column 26 has a diamond shape. However, the shape of the electrode in the present invention is not limited to the diamond shape and may be implemented by various suitable shapes, so the shape of the electrodes may have other shapes as well such as rectangles, or other polygon shapes, which could meet the actual design requirements. Compared with a conventional process using ITO for forming an electrode layer, the electrode layer 22 of the embodiment may be directly subjected to a photolithographic process, thereby simplifying the overall process to reduce cost.

In the embodiment, the substrate 21 may be a transparent substrate, which may include, for example, glass, polyester or other transparent material. However, the substrate 21 may also include flexible material, rigid material or a LCD Module, according to actual design requirements. As the metal wires included in the non-transparent conductive material mentioned above are very thin in diameter, the metal wires may accompany the substrate 21 to form a flexible touch electrode device 200. To the contrary, indium tin oxide (ITO), which is conventionally used as transparent conductive material, suffers from fracture and therefore ITO is difficultly adapted to make a flexible touch electrode device. Alternatively speaking, ITO has flexibility substantially lower than the electrode layer 22 including metal wires as disclosed in the embodiment.

FIG. 2E shows a cross-sectional view of a modified touch electrode device 200, which further includes insulation layer 27 disposed between the substrate 21 and the electrode layer 22, such that the electrode layer 22 is indirectly disposed on the surface of the substrate 21. In an embodiment, the insulation layer 27 may include photoresistive material, which may then be patterned along with the electrode layer 22 via photolithographic process. In another embodiment, the insulation layer 27 may include photoresistive material or polymeric material, such that a surface of the insulation layer 27 may have adhesive property. Therefore, the insulation layer 27 may be effectively fixed to the substrate 21 or the electrode layer 22.

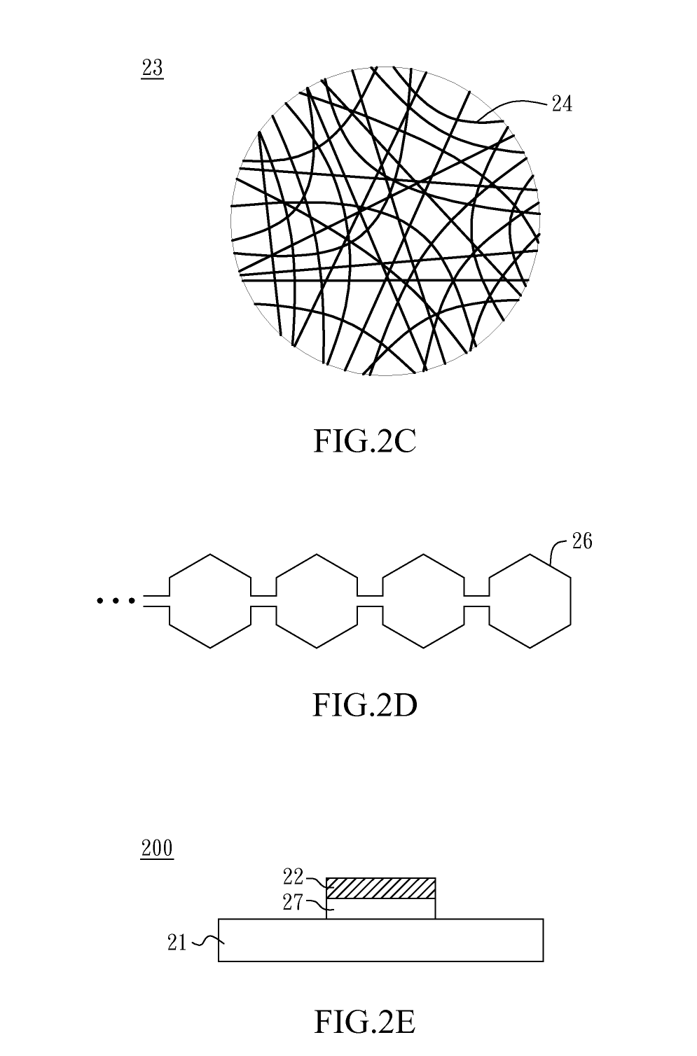

The touch electrode device 200 illustrated in FIG. 2B and FIG. 2E, that is, a single transparent electrode layer 22 is disposed on a single surface of the substrate 21. The embodiment, however, may adopt other structures, for example, a single-side double-layer structure or a double-side structure. FIG. 3A shows a top view of a touch electrode device 300 with a single-side double-layer structure, and FIG. 3B shows a cross-sectional view along a section line 3-3′ in FIG. 3A. Specifically, a first electrode layer 22A and a second electrode layer 22B are formed in sequence on a surface of the substrate 21, and the first electrode layer 22A and a second electrode layer 22B are insulated from each other by an insulation layer 27. Furthermore, the insulation layer 27 may be subjected directly to a photolithographic process to result in having the same patterns as those of the electrode layer 22. However, the insulation layer 27 in the present invention is not limited thereto, and may be implemented to have various suitable shapes according to actual design requirements.

The first/second electrode layer 22A/22B may include non-transparent conductive material (e.g., metal wires, a copper mesh or a silver mesh), or the electrode layer may he made of transparent conductive material (e.g., ITO, AZO, TZO, GZO or FTO).

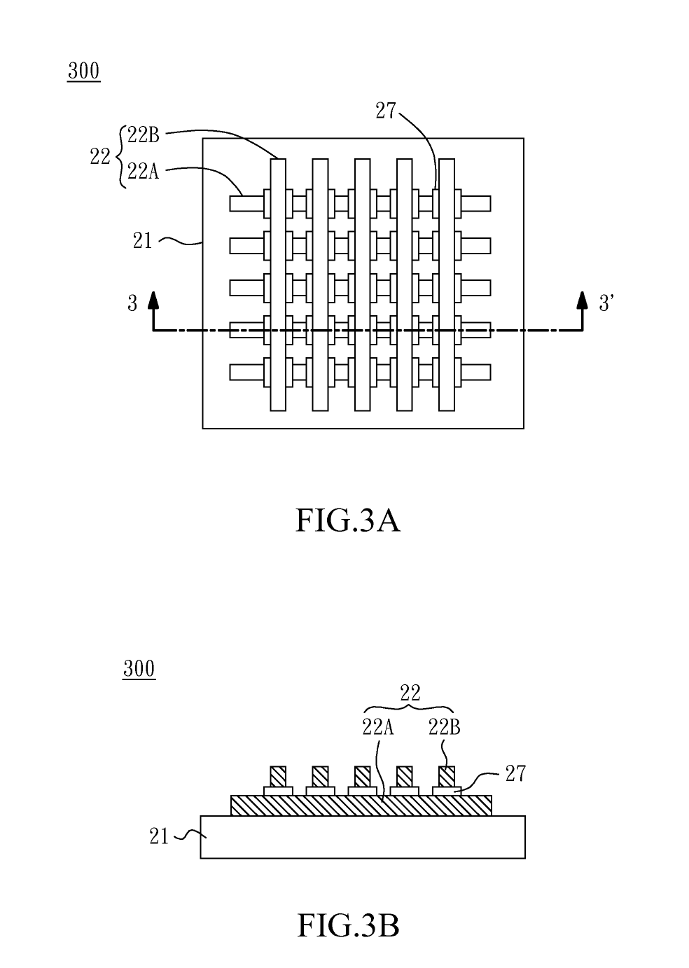

FIG. 4A shows a top view of a touch electrode device 400 with a double-side structure, and FIG. 4B shows a cross-sectional view along a section line 4-4′ in FIG. 4A. Specifically, the first electrode layer 22A and the second electrode layer 22B are formed on opposite surfaces of the substrate 21. The first/second electrode layer 22A/22B may include non-transparent conductive material (e.g., metal wires, a copper mesh or a silver mesh), or the electrode layer may be made of transparent conductive material (e.g., ITO, AZO, TZO, IZO, GZO or FTO).

Compared with the conventional touch electrode devices, the touch electrode device 200/300/400 of the embodiment includes the electrode layer 22 having non-transparent conductive material, therefore making it flexible. The touch electrode device 200/300/400 discussed above may be adapted to a variety of touch structures (particularly capacitor-based touch structures), such as touch panels or touch display panels, to show advantages mentioned above by way of some examples demonstrated below.

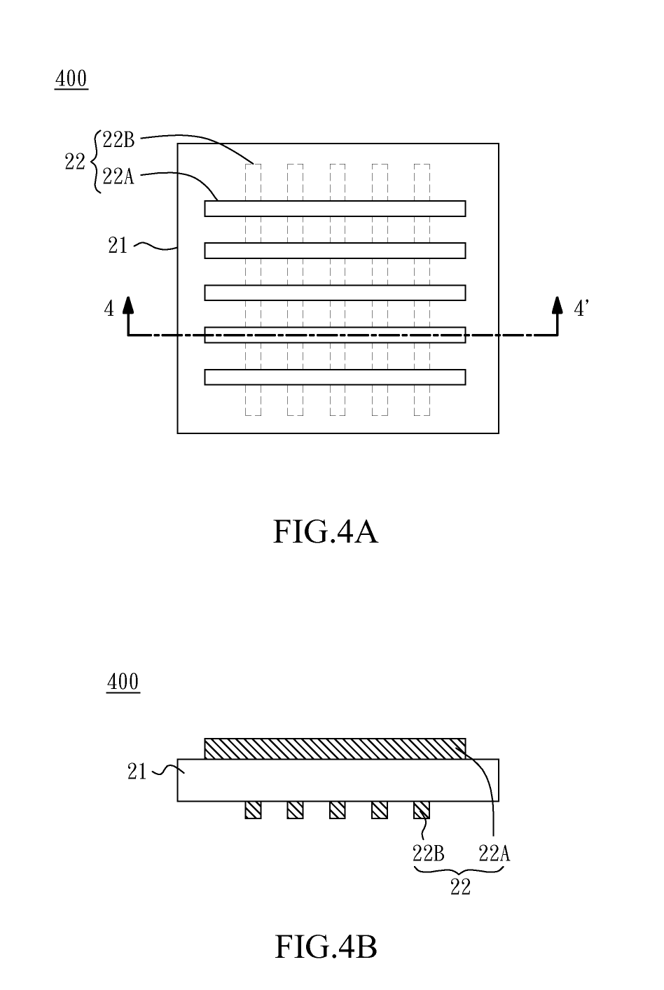

FIG. 5A shows a cross-sectional view of a touch display 3 adopting the embodiment. For better understanding, only composing elements pertinent to the touch display 3 are shown. As shown in FIG. 5A, the touch display 3 is formed by stacking a display panel 320 and a touch panel 310. Specifically, the display panel 320 primarily includes a liquid crystal (LC) layer 31 and a color filter (CF) 32. The touch panel 310 primarily includes a polarizer 33 and an electrode layer 22, which is disposed on a top surface of the polarizer 33, and the polarizer 33 acts as the substrate 21 in FIG. 2A through FIG. 4B. The electrode layer 22 of FIG. 5A may include a single electrode sub-layer or multiple electrode sub-layers (e.g., the first electrode layer 22A and the second electrode layer 22B mentioned above). The display panel 320 in the exemplary embodiment may be a flexible display panel 320, which may accompany a flexible touch panel 310 to form a flexible touch display 3.

FIG. 5B shows a cross-sectional view of another touch display 3′ adopting the embodiment. The present embodiment differs from FIG. 5A in that the electrode layer 22 of FIG. 5B is disposed on a bottom surface of the polarizer 33.

In another embodiment, still referring to FIG. 5B, the electrode layer 22 is disposed on a top surface of the color filter (CF) 32, which acts as the substrate 21 in FIG. 2A through FIG. 4B.

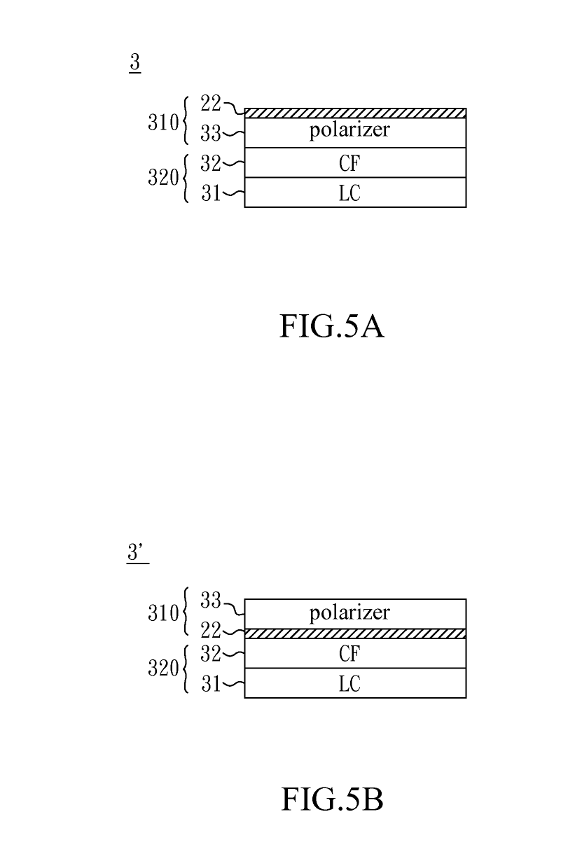

FIG. 6 shows a cross-sectional view of a touch panel 5 adopting the embodiment. In the present exemplary embodiment, the first electrode layer 22A, the insulation layer 27 and the second electrode layer 22B are disposed on a bottom surface of a cover glass 51 in sequence. The cover glass 51 acts as the substrate 21 in FIG. 2A through FIG. 4B, and the cover glass 51 may have a two-dimensional or three-dimensional profile, which may be applied to a two-dimensional or a three-dimensional touch display, respectively. In one embodiment, the cover glass 51 may include flexible material or rigid material, and the surface material of the cover glass may be treated to have anti-wear, anti-scratch, anti-reflection, anti-glare and anti-fingerprint features.

The touch displays 3, 3′ and 5 illustrated above are just some exemplary applications adopting the touch electrode devices 200, 300 and 400 according to the embodiment of the present invention. It is appreciated that the electrode layer 22 may be applied to replace the conventional electrode layer in a variety of flexible or non-flexible touch structures.

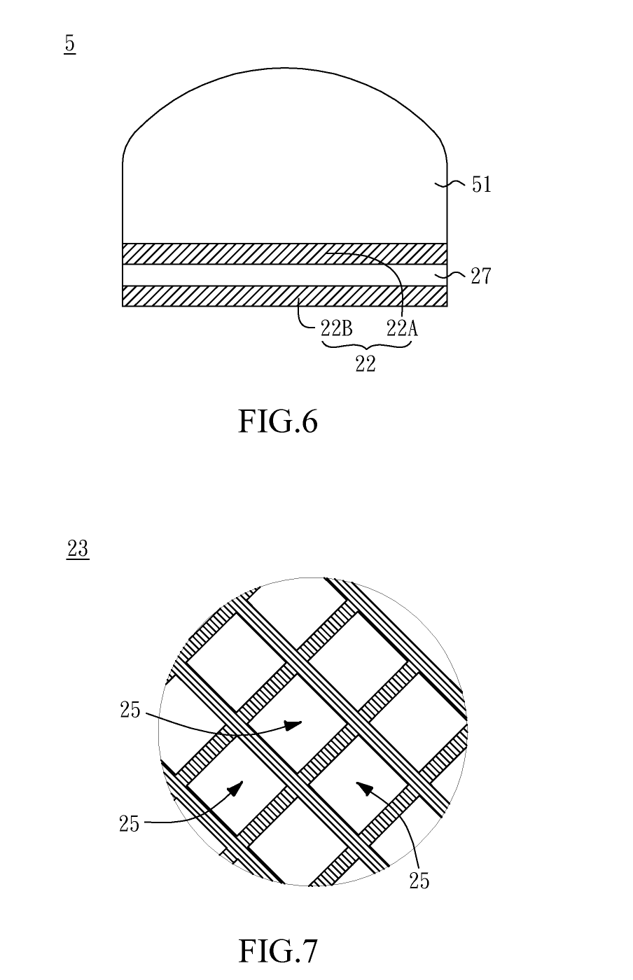

FIG. 7 shows a partial enlarged section 23 of the electrode layer made of a copper mesh, according to another embodiment of the present invention. As shown in FIG. 7, the copper mesh has a plurality of cells 25. Each cell 25 may have a polygon shape or a quasi-circular shape, and the intervals of the cells may be fully penetrated by the light. Moreover, the cells 25 may be electrically connected with each other and arranged into a matrix pattern. Consequently, the electrodes may be formed by the arrangement of the cells 25, which may form a rectangular shape, a diamond shape or other polygonal shapes. Although this embodiment is illustrated with copper mesh, the present invention is not limited to thereto, and the aspects of the present invention mentioned above may also be realized by a silver mesh or other suitable material.

In another embodiment, the non-transparent conductive material may further include adhesive material, such as the optical cement or other transparent insulating adhesive materials, and therefore, the electrode layer 22 may be fixed to a surface of the substrate 21.

Although specific embodiments have been illustrated and described, it will be appreciated by those skilled in the art that various modifications may be made without departing from the scope of the present invention, which is intended to be limited solely by the appended claims.

What is claimed is:

1. A touch electrode device, comprising:
a substrate; and
at least one electrode layer disposed above the a surface of the substrate, the electrode layer including a non-transparent conductive material.

2. The device of claim 1, further comprising an insulation layer disposed between the electrode layer and the substrate.

3. The device of claim 2, wherein the insulation layer comprises insulation material.

4. The device of claim 2, wherein the at least one electrode layer comprises a first electrode layer and a second electrode layer disposed above a same surface of the substrate; and the insulation layer is disposed between the first electrode layer and the second electrode layer for electrical insulation therebetween.

5. The device of claim 1, wherein the at least one electrode layer comprises a first electrode layer and a second electrode layer disposed on opposite surfaces of the substrate, respectively.

6. The device of claim 1, wherein the non-transparent conductive material comprises a plurality of metal wires, a copper mesh or a silver mesh.

7. The device of claim 6, wherein the metal wire has a diameter of some nanometers to hundreds of nanometers.

8. The device of claim 6, wherein the metal wires are flatly distributed.

9. The device of claim 1, wherein the non-transparent conductive material further comprises photoresistive material.

10. The device of claim 1, wherein the non-transparent conductive material further comprises adhesive material.

11. The device of claim 1, wherein the electrode layer further comprises plastic material, for fixing the non-transparent conductive material in the electrode layer.

12. The device of claim 1, wherein the substrate is a transparent substrate.

13. The device of claim 2, wherein the insulation layer further comprises photoresistive material.

14. The device of claim 1, wherein the substrate comprises a polarizer, and the electrode layer is disposed on a top surface or a bottom surface of the polarizer.

15. The device of claim 1, wherein the substrate comprises a color filter and the electrode layer is disposed on a top surface of the color filter.

16. The device of claim 2, wherein the substrate comprises a cover glass, and the at least one electrode layer is disposed. on a bottom. surface of the cover glass.

17. The device of claim 16, wherein the at least one electrode layer comprises a first electrode layer and a second electrode layer, wherein the first electrode layer, the insulation layer and the second electrode layer are disposed on the bottom surface of the cover glass in sequence.

18. The device of claim 16, wherein the cover glass comprises flexible material or rigid material.
